(19) United States
(12) Patent Application Publication
(10) Pub. No.: US 2012/0089518 A1
(43) Pub. Date: Apr. 12, 2012

(54) METHOD AND SYSTEM FOR AUTHENTICATING PRESCRIPTIONS FOR CONTROLLED SUBSTANCES

(76) Inventor: Robert Blonchek, West Friendship, MD (US)

(21) Appl. No.: 12/900,538

(22) Filed: Oct. 8, 2010

(51) Int. Cl. G06Q 50/00; G06K 19/06; G06Q 10/00; H04L 9/32

(52) U.S. Cl. 705/50; 705/3; 235/494

(57) ABSTRACT

A method and system for two-factor authentication of electronic prescriptions for controlled substance is characterized by the tagging of discreet prescription identifiers, created by an electronic medical record system, with a unique identification number and encoding the identification number in an electronically readable identifier. The identifier is created using an electronic network service that creates the unique identification number and the electronically readable identifier. When provided with the unique identification number and the electronically readable identifier, a health care practitioner can authenticate the electronic prescription using a standard smartphone or other mobile device. The result is a highly-scalable, convenient and easy-to-use authentication method for electronically prescribing controlled substances that takes advantage of standard smartphones and other mobile devices now used by a majority of healthcare practitioners, reduces the authentication burden caused by the Drug Enforcement Administration's two-factor authentication requirement for electronically prescribing controlled substances, and reduces the need for the healthcare enterprise to purchase and provide practitioners with additional authentication devices or other equipment to implement a two-factor authentication mechanism.

### FIELD OF THE INVENTION

The invention relates to a method and system for two-factor authentication of electronic prescriptions for controlled substances via the use of two-dimensional barcode technology and mobile devices.

### BACKGROUND OF THE INVENTION

The writing of electronic prescriptions (“EP”) using electronic prescription applications (“EPA”) is well known. These applications have been available for a number of years and are anticipated by many to improve healthcare and possibly reduce costs by improving compliance with formularies and increasing the use of generic medications.

An EPA may be a stand-alone application or may be integrated into an electronic medical record (“EMR”) system that creates and links all medical records and associated information. An EPA allows medical practitioners, such as physicians, to create a prescription electronically and accommodates different means of transmitting the prescription to a pharmacy. Practitioners may print the prescription for manual signature; the prescription may then be given to the patient or the practitioner's office may fax it to a pharmacy. Some applications will automatically transmit an image of the prescription as a facsimile. True electronic prescriptions, however, are transmitted as electronic data files to the pharmacy, where applications import the data file into the pharmacy's database. Virtually all pharmacies maintain prescription records electronically and prescriptions that are not received as electronic data files are manually entered into the pharmacy application.

In addition the use of mobile devices and bar code technology within the health care industry in general, and with EPs and EPAs is also well known. For example, U.S. Pat. No. 7,630,908 sets forth a method and system for creating and managing prescriptions through use of portable digital assistants and bar code technology. The invention provides methods for electronically sending prescription information between client systems operated by prescribers and client systems at pharmacies via a server system at a central site where prescription information is stored. Creating and sending prescriptions are coordinated by a web service. In the invention, bar code technology is used to automate certain steps of prescription creation including entering patient information and prescription information by scanning a bar code. A bar code and corresponding bar code reference number are generated for each prescription and are used to access the prescription information in a database.

Although the adoption of EPAs and the use of EPs is increasing, use of these applications has been restricted because of the inability to use EPAs for all prescriptions. Applicable laws and the related Drug Enforcement Administration (“DEA”) regulations that have been in effect have provided that a controlled substance may only be dispensed by a pharmacy pursuant to a written prescription or oral prescription. Controlled substances are drugs and other substances that have a potential for abuse and psychological and physical dependence, and include opioids, stimulants, depressants, anabolic steroids, and drugs that are immediate precursors of these classes of substances.

DEA regulations divide controlled substances into five schedules: Schedule I substances have a high potential for abuse and have no currently accepted medical use in treatment in the United States. These substances may only be used for research, chemical analysis, or manufacture of other drugs. Schedule II-V substances have currently accepted medical uses in the United States, but also have potential for abuse and psychological and physical dependence that necessitate control of the substances. The vast majority of Schedule II, III, IV, and V controlled substances are available only pursuant to a prescription issued by a practitioner licensed by a State and registered with the DEA to dispense the substances. Applicable laws provide that controlled substances in Schedule II may only be dispensed by a pharmacy pursuant to a written prescription, except in emergency situations. In contrast, for controlled substances in Schedules III and IV, applicable laws provide that a pharmacy may dispense them pursuant to a written or oral prescription. DEA regulations further provide that a practitioner may transmit to the pharmacy a facsimile of a written, manually signed prescription in lieu of an oral prescription.

Without the ability to prescribe controlled substances electronically, today's e-prescribing workflow is fractured. For example, a practitioner can write a prescription for an antibiotic using a fully electronic end-to-end secure transaction. However, the same practitioner, for the same encounter with the same patient, would have to write a prescription for a controlled substance, such as Oxycontin, with a pen and paper. With a fully electronic prescription workflow, however, a practitioner can write prescriptions for all medications to the pharmacy of the patient's choice without a pen or paper.

To address the issues presented by the inability to electronically prescribe controlled substances, to reduce paperwork, to reduce the number of prescription errors, and to increase efficiency within the healthcare system, the DEA has revisited its regulations to provide practitioners with the option of writing prescriptions for controlled substances electronically.

The revised DEA regulations provide for requirements that must be met by any system to be used to electronically prescribe controlled substances. One such requirement is the need for two-factor authentication when prescribing controlled substances. Two-factor authentication means proving authentically the identity of a requestor of access to a secure system, such as an EPA, by means of the independent use of two of the following three generally accepted authentication methods:
What the requestor individually knows as a secret, such as a password or a Personal Identity Number (“PIN”), or
What the requestor uniquely has, such as a passport, an ID-card, or a device separate from the computer to which the requestor is gaining access, or
What the requestor individually is, such as biometric data, like a fingerprint or iris scan.

The use of two-factor authentication can increase the assurance that the requestor has been authorized to access the secure system.

The use of two-factor authentication to facilitate the EP of controlled substances has workflow implications for practitioners, because of the added authentication burden, and has cost implications for the healthcare enterprise that must implement new authentication methods that can involve buying expensive equipment or devices. Therefore, an improved system and method for two-factor authentication is needed that reduces or eliminates the added authentication burden without imposing burdensome costs on the healthcare enterprise.

### SUMMARY OF THE INVENTION

Accordingly, it is a primary object of the invention to provide a method and system which allows an individual healthcare practitioner to use his or her existing smartphone or other mobile device, along with two-dimensional bar code technology, as an authentication device that is separate from an EPA and compatible with the: “what the requestor uniquely has” generally accepted authentication method described above, thus providing a two-factor authentication solution for the electronic prescription of controlled substances. Methods and systems are also disclosed for tagging and staging an electronic prescription identifier with a Unique Identification Number (“UIN”), and encoding the UIN along with other information in an Electronically Readable Identifier (“ERI”).

A UIN is a string of Base 64-encoded characters that is calculated using a cryptographic hash function operating on a globally unique identifier (“GUID”). A GUID is a 128-bit integer (16 bytes) that can be used across all computers and networks, with a very low probability of being duplicated. An ERI is a high capacity barcode that employs different symbol shapes in geometric patterns and/or multiple colors to provide more information in less space than traditional barcodes.

According to the invention, an EMR system, or other health information system, implements two-factor authentication for electronically prescribing controlled substances by tagging discreet electronic prescriptions identifiers (“EPI”) with a UIN. The EMR creates the UIN using a method chosen by the EMR software vendor and the ERI is created through the use of a web service accessible via the Internet, using a Representational State Transfer (“REST”) interface, sometimes referred to as a “RESTful” interface. A RESTful interface is a style of software architecture for web services, built around the transfer of representations of resources, where a resource is any coherent and meaningful concept that may be addressed.

The web service stores the EPI in a staging database along with the UIN. The EPI does not contain identifying information for the individual, nor does it include information about the underlying medication. It is encrypted using the Data Encryption Standard (“DES”) algorithm before it is staged, thus enhancing the security and privacy of the individual that is to receive the prescribed medication, and reducing the potential for the prescription information to be improperly used.

The web service returns an ERI to the EMR system that contains the UIN and a Uniform Resource Identifier (“URI”). The URI is a string of characters used to identify a resource on the Internet for another REST-based web service that is designed to authenticate the practitioner that has created the EP and to notify the EMR system that the practitioner has successfully authorized the EP.

The UIN and ERI are physically provided to the practitioner by the EMR system by displaying them on a computer screen or other display device, by printing them, or by delivering them electronically to the practitioner by electronic mail or other electronic mechanism.

The practitioner scans the ERI using a standard smart phone or other mobile device equipped with a camera, an Internet connection, and image-processing software that decodes the ERI. This action causes the transmission of the EPI to a web service identified by the URI encoded in the ERI as described above. The web service challenges the practitioner for a user name and password and PIN code, verifies that the EPI is associated to the authenticating practitioner, and verifies that the physical device used to scan the ERI is registered to the authenticated practitioner, in order to ensure that only the ERI's originating practitioner can authenticate the EPI using a specific, physical mobile device that is known to be registered to the practitioner. The web service then notifies the EMR system that the two-factor authentication process has been successfully completed so that the EMR system can forward the prescription information to the pharmacy for fulfillment.

The result is a highly-scalable, convenient and easy-to-use authentication method for electronically prescribing controlled substances that takes advantage of standard smartphones and other mobile devices now used by a majority of healthcare practitioners, takes advantage of standard two dimensional bar code technology that is widely used within the healthcare system, reduces the authentication burden caused by the DEA's two-factor authentication requirements, and reduces the need for the healthcare enterprise to purchase and provide practitioners with additional authentication devices or purchase other equipment and software to implement biometric scanning or other security techniques. In addition the invention provides increased security, auditing, and tracking capabilities by providing for the guarantee that a specific authorized practitioner must use a known and registered smartphone to authenticate a prescription, and by providing for the simple authentication and authorization of discreet controlled substance prescriptions, instead of just authenticating the practitioner's access to an EPA. Finally, the invention provides increased security by eliminating the need to transmit any specific patient information, or information about the underlying controlled substance or the prescription information over an electronic network.

Other embodiments of the invention use the same methods to authenticate the individual practitioner's access to an EPA instead of authenticating discreet controlled substance prescriptions created by the practitioner.

### BRIEF DESCRIPTION OF THE FIGURES

Other objects and advantages of the invention will become apparent from a study of the following specification when viewed in the light of the accompanying drawing, in which:

FIG. 1 is a flow chart showing the steps taken to stage an EPI in the staging database;

FIG. 2 is a flow chart showing the steps taken to transmit and authenticate the EPI and to notify the EMR system that the authentication process successfully completed;

### DETAILED DESCRIPTION

The present invention relates to methods and systems which allow the tagging, staging and transmission of an EPI that represents the data associated with a discrete prescription for a controlled substance created by a health information system such as an EMR, in order to authenticate the prescription in accordance with DEA regulations. By tagging and transmitting a discreet EPI, the healthcare practitioner is provided with an easy and convenient authentication method that takes advantage of standard smartphone technology that most healthcare practitioners now use.

An EPI is a unique identification number generated by an EMR or other system to identify and track an electronic prescription for a controlled substance.

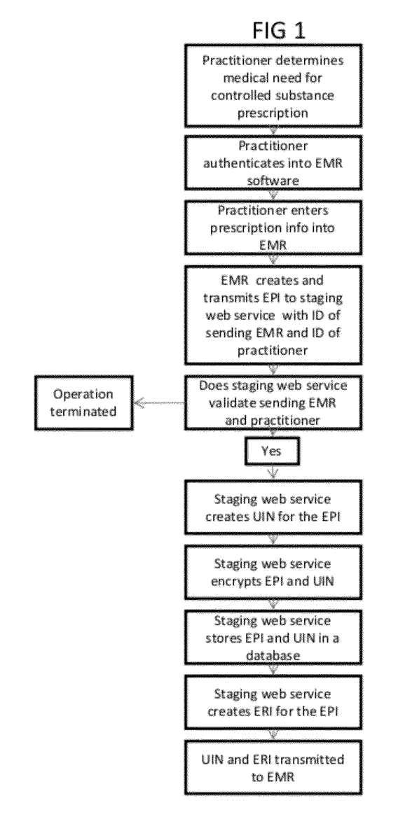

As shown in FIG. 1, once a physician or other health care provider completes a patient's clinical examination or procedure and determines that a prescription for a controlled substance is medically necessary, he records the prescription information in an EMR accessible via a computer in the health care facility where the examination or treatment is taking place, and to which he has been authenticated. When directed by the health care provider, the EMR system creates an EPI for the controlled substance prescription. The format and content of the EPI are determined by the EMR software.

Once the EPI is generated, the EMR system digitally signs and transmits the EPI along with unique identifiers representing the sending EMR system and identifying the prescribing physician, and a callback URI that the web service will access to provide the results of the authentication process, to a staging web service using a RESTful interface.

When the staging web service receives the EPI and the unique identifiers, it validates that the sending EMR and health care provider are authorized to connect to the web service. If either the sending EMR or health care provider is unauthorized, the staging request is rejected and the sending EMR system is notified of the error condition.

Once the sending EMR and health care provider are authenticated, the staging web service creates a UIN for the EPI.

A UIN is a string of Base 64-encoded characters that is calculated using a cryptographic hash function operating on a GUID. A GUID is a 128-bit integer (16 bytes) that can be used across all computers and networks, with a very low probability of being duplicated. It is created by combining a unique place, represented by the network media access control (“MAC”) address of the computer creating the GUID, and a unique instant in time expressed as the current date and time of day.

The staging web service next encrypts the EPI using the DES algorithm and stores the encrypted EPI along with the UIN in a staging database.

The staging web service then creates an ERI for the EPI by encoding a URI for a web service that is designed to challenge the practitioner for a username, password and PIN Code in order to authenticate the ERI, in a two-dimensional, high capacity barcode. The URI includes a query string parameter that is the UIN after being encrypted using the DES algorithm. The URI also includes an additional query string parameter that will cause the mobile device to generate and report a unique identification number when the physician scans the ERI using a scanner such as is available in a smartphone. The URI also includes a digital signature and other data that ensures that only one authentication attempt using the ERI can be attempted, and that ensures that the physician must scan the ERI within a fixed period of time.

An ERI is a high capacity barcode that employs different symbol shapes in geometric patterns and/or multiple colors to provide more information in less space than traditional barcodes.

Finally, the staging web service transmits the UIN and ERI to the EMR system.

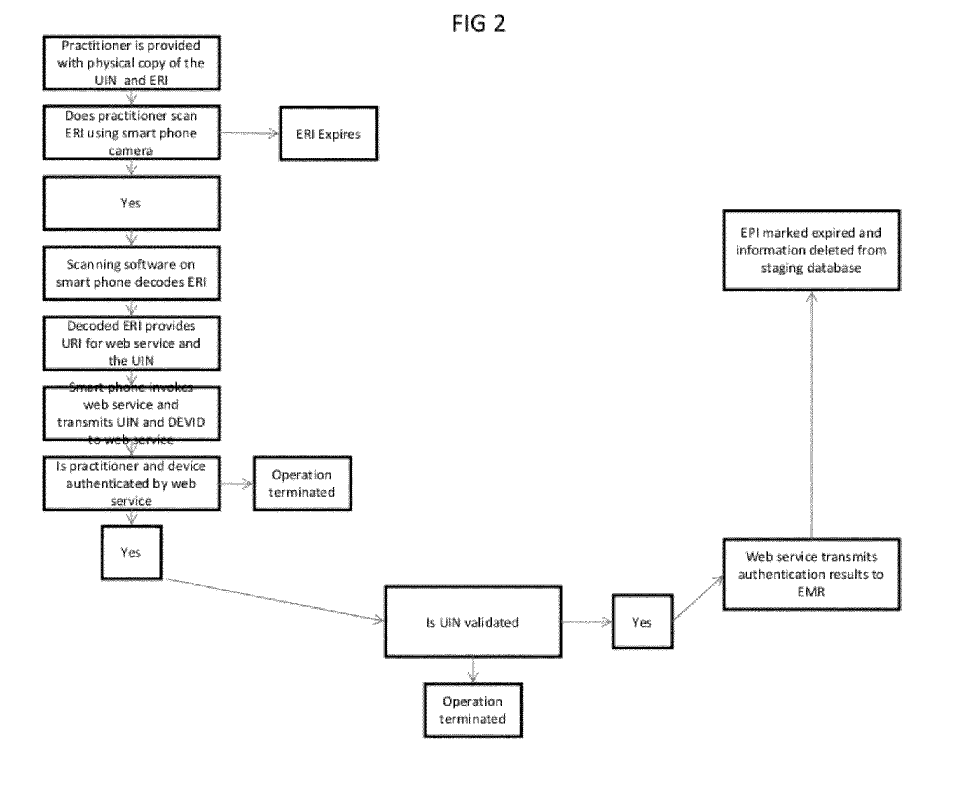

As shown in FIG. 2, the practitioner is provided with a physical copy of the UIN and ERI. This can be accomplished in multiple ways including printing the barcode image and UIN character string on a document such as a prescription form, or the UIN and ERI can be sent to the practitioner electronically using electronic mail or other mechanism. Other approaches include displaying the UIN and/or ERI to the practitioner using a display device or kiosk located in the health facility where the practitioner is providing medical treatment or services.

Once the practitioner has physical custody of the UIN and EIN, he may use the camera on a smart phone or other mobile device to scan the ERI. Image-processing software on the mobile device decodes the barcode image and extracts the URI, which includes the encrypted UIN, from the ERI. The mobile device also generates a unique device identification code (DEVID) and appends it to the extracted URI. The DEVID is an anonymous but persistent number that uniquely identifies a particular mobile phone. This number varies depending on the type of mobile phone and is sometimes based on another device-specific number such as the device serial number or an International Mobile Equipment Identity (IMEI) number, but it does not correspond to any other identification system.

The mobile device then invokes a web service using the URI via an Internet browser installed on the mobile device, which has the effect of transmitting the UIN of the EPI, the DEVID, the digital signature, and additional information to the web service.

The web service authenticates the practitioner by challenging him for a username and password and or a PIN. If the individual is not authenticated the operation is terminated.

If the practitioner does not scan the ERI with a mobile device the ERI will expire after a period of time and the associated EPI is deleted from the staging database.

When the practitioner is authenticated, the web service decrypts the UIN and validates that an EPI with the corresponding UIN is staged in the staging database, and validates that the EPI is associated to the practitioner that was authenticated. In addition the web service will verify that the DEVID is registered to the authenticated practitioner. If the EPI is not found, the practitioner is denied access to the EPI, or the DEVID is not registered to the practitioner, the operation is terminated.

When the practitioner, the EPI, and the device have been authenticated and validated, the EMR system is notified that the authentication process was successfully completed using the callback URI provided by the EMR system when making the authentication request. The response will include a status code indicating the success or failure of the authentication process, the original EPI so that the EMR can match the response with the original request, and a security verifier that proves to the EMR system that the response is coming from the trusted web service. The web service then marks the EPI as expired and deletes the associated prescription information from the staging database, further ensuring the security of the transaction.

While the preferred embodiment of the subject invention has been illustrated and described, it will be apparent to those of ordinary skill in the art that various changes and modifications may be made without deviating from the inventive concepts set forth above.

1. A method for authenticating an electronic medical record system access request, comprising the steps of
(a) generating a discrete system access request identifier via the electronic medical record system;
(b) generating a first unique identifier for the electronic medical record system via a staging electronic communication system;
(c) generating a second unique identifier via the staging electronic communication system for a medical professional requesting access to the electronic medical record system in order to create an electronic prescription;
(d) generating a unique device identification code via the staging electronic communication system for a mobile communication device registered to the medical professional; and
(e) transmitting said system access request identifier, said first identifier for the electronic medical record system, said second unique identifier for the medical professional, and said unique device identification code via a staging electronic communication system, whereby access to the staging electronic communication system can be authenticated for the electronic medical record system and the medical professional.

2. A method as defined in claim 1, and further comprising the steps of generating and transmitting a callback uniform resource identifier that is accessed by the staging electronic communication system to communicate the result of the system access request authentication process to the electronic medical record system.

3. A method as defined in claim 2, wherein said staging electronic communication system comprises the internet.

4. A method as defined in claim 2, wherein said system access request identifier, said first unique identifier for the electronic medical record system, said second unique identifier for the medical professional, and said callback uniform resource identifier are transmitted to the staging electronic communication system using a representational state transfer.

5. A method as defined in claim 4, wherein said staging electronic communication system validates that the electronic medical record system and the medical professional are authorized to connect with the staging electronic communication system.

6. A method as defined in claim 5, wherein said staging electronic communication system generates a unique internal identification number for the system access request identifier.

7. A method as defined in claim 6, wherein said unique identification number is calculated using a cryptographic hash function operating on a globally unique identifier.

8. A method as defined in claim 7, wherein said globally unique identifier is calculated as a function of the network access control address of the device which calculates the globally unique identifier and the time at which the globally unique identifier is generated.

9. A method as defined in claim 6, wherein said staging electronic communication system encrypts said unique identification number for the system access request identifier using a Data Encryption Standard algorithm and stores the encrypted unique identification number and said system access request identifier in a staging database.

10. A method as defined in claim 9, wherein said staging electronic communication system creates an electronically readable identifier for the system access request identifier by appending a uniform resource identifier with the encrypted unique identification number and said unique device identification code.

11. (canceled)

12. A method as defined in claim 10, wherein said electronically readable identifier is in the form of a high capacity barcode.

13. A method as defined in claim 10, wherein said staging electronic communication system transmits said electronically readable identifier to the electronic medical record system.

14. A method as defined in claim 13, and wherein said electronic medical record system generates a physical copy of the electronically readable identifier for the medical professional who requests access to said electronic medical record system.

15. A method as defined in claim 14, wherein the medical professional scans the electronic record identifier with a mobile communication device to invoke the unique resource identifier.

16. (canceled)

17. (canceled)

18. A method as defined in claim 15, and further comprising the steps of notifying the electronic medical record system using said callback uniform resource identifier that authentication failed when the unique identification number and device identification code are not validated, and notifying the electronic medical record system using said callback uniform resource identifier that authentication was successful when the unique identification number and device identification code are validated, and further wherein access to said electronic communication system is password protected.

19. A method as defined in claim 18 and further comprising the step of marking the system access request identifier as expired following the authentication process and deleting the associated request information from the staging electronic communication system.

20. (canceled)
